(19) United States
(12) Patent Application Publication
(10) Pub. No.: US 2025/0003839 A1
(43) Pub. Date: Jan. 2, 2025

(54) TESTING SYSTEM AND TESTING METHOD FOR MAGNETIC REFRIGERATOR

(71) Applicant: Baotou Research Institute of Rare Earths, Baotou (CN)

(72) Inventors: Peiyu JIN, Baotou (CN); Jiaohong HUANG, Baotou (CN); Yingde ZHANG, Baotou (CN); Cuilan LIU, Baotou (CN); Juan CHENG, Baotou (CN); Zhaojie LI, Baotou (CN); Mohan DAI, Baotou (CN); Qiang WANG, Baotou (CN); Yaru GUO, Baotou (CN); Lei GAO, Baotou (CN); Pengyu WANG, Baotou (CN); Hao PEI, Baotou (CN); Jianping ZHANG, Baotou (CN)

(73) Assignee: Baotou Research Institute of Rare Earths, Baotou (CN)

(21) Appl. No.: 18/593,918

(22) Filed: Mar. 3, 2024

(30) Foreign Application Priority Data
Jun. 28, 2023 (CN) 202310774281.5

(51) Int. Cl. G01M 99/00; F25B 21/00

(52) U.S. Cl. CPC G01M 99/007; F25B 21/00; F25B 2321/0021

(57) ABSTRACT

Disclosed are a testing system and testing method for a magnetic refrigerator. In the system, an adjustable load includes a heating container, and a flow direction control structure. The heating container is provided with an inlet, an outlet, and a heater with controllable heating power. The flow direction control structure is configured to enable a heat exchange fluid flowing out from a cold end of any magnetic regenerator module in magnetic regenerator modules arranged in pairs to flow into a cold end of another magnetic regenerator module through the inlet and outlet of the heating container in sequence, the heater is used to heat the heat exchange fluid inside the heating container, and an on-off state between the adjustable load and the cold end of any magnetic regenerator module is controllable.

### CROSS-REFERENCE TO RELATED APPLICATION

This patent application claims the benefit and priority of Chinese Patent Application No. 202310774281.5, filed with the China National Intellectual Property Administration on Jun. 28, 2023, the disclosure of which is incorporated by reference herein in its entirety as part of the present application.

### TECHNICAL FIELD

The present disclosure relates to the technical field of magnetic refrigeration, and in particular to a testing system and testing method for a magnetic refrigerator.

### BACKGROUND

This section is intended to provide background or context for the embodiments set forth in claims. The description here is not admitted to be prior art just because it is included in this section.

Magnetic refrigeration is a solid-state refrigeration technology, which is a novel refrigeration technology expected to replace the traditional gas compression refrigeration technology.

A cold end of a regenerator of the traditional magnetic refrigerator is connected to a cold end radiator, which is used as the traditional cold end load. When the load needs to be replaced with other loads with other power, the connected cold end load needs to be dismounted, leading to the increase of the workload of testing.

### SUMMARY

A testing system and testing method for a magnetic refrigerator are provided by the present disclosure.

The present disclosure employs the following technical solution: a testing system for a magnetic refrigerator is provided. The magnetic refrigerator includes magnetic regenerator modules arranged in pairs. The testing system includes:
an adjustable load, including a heating container, and a flow direction control structure, where the heating container is provided with an inlet, an outlet, and a heater with controllable heating power, the flow direction control structure is configured to enable a heat exchange fluid flowing out from a cold end of any magnetic regenerator module in the magnetic regenerator modules arranged in pairs to flow into a cold end of another magnetic regenerator module through the inlet and outlet of the heating container in sequence, the heater is used to heat the heat exchange fluid inside the heating container, and an on-off state between the adjustable load and the cold end of any magnetic regenerator module is controllable;
at least one fixed load, where a first end of any fixed load communicates with the cold end of one magnetic regenerator module in the magnetic regenerator modules arranged in pairs in a controlled manner, and a second end of the any fixed load communicates with the cold end of another magnetic regenerator module in the magnetic regenerator modules arranged in pairs in a controlled manner; and
multiple temperature sensors, used to measure a temperature of the heat exchange fluid at each of a hot end and the cold end of at least one of the magnetic regenerator modules arranged in pairs, a temperature of the heat exchange fluid at the heating container, and a temperature of the heat exchange fluid at each fixed load.

Alternatively, the magnetic regenerator modules arranged in pairs are respectively a first magnetic regenerator module and a second magnetic regenerator module. The flow direction control structure includes a first check valve, a second check valve, a third check valve, and a fourth check valve.

An inlet of the first check valve and an outlet of the third check valve both communicate with the cold end of the first magnetic regenerator module through a same electric control valve. An inlet of the second check valve, and an outlet of the fourth check valve both communicate with the cold end of the second magnetic regenerator module through a same electric control valve. An outlet of the first check valve and an outlet of the second check valve both communicate with a heat exchange fluid inlet of the heating container. An inlet of the third check valve and an inlet of the fourth check valve both communicate with a heat exchange fluid outlet of the heating container.

Alternatively, both ends of any fixed load communicate the cold ends of the corresponding magnetic regenerator modules through electric control valve, respectively.

Alternatively, the at least one any fixed load includes a first fixed load and a second fixed load, where a heat capacity of the first fixed load is less than that of the second fixed load.

Alternatively, the magnetic regenerators modules arranged in pairs have equal refrigeration power.

Alternatively, each of the magnetic regenerator modules arranged in pairs has one or more active magnetic regenerators communicating with one another.

Alternatively, hot end temperatures of the magnetic regenerator modules arranged in pairs are set to be constant and equal.

The present disclosure employs the following technical solution: a testing method applied to the testing system for a magnetic refrigerator includes the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

Alternatively, the hot end temperatures of the magnetic regenerator modules arranged in pairs are set to be constant and equal.

Alternatively, the method further includes: setting the adjustable load to be disconnected from the cold end of any magnetic regenerator module, setting at least one fixed load to be in conducting with the cold end of any magnetic regenerator module, setting rest fixed loads to be disconnected from the cold end of any magnetic regenerator module, and measuring a change curve of the cold end temperature and a change curve of the hot end temperature of any magnetic regenerator module with time.

The load of the testing system can be flexibly switched between the fixed load and the adjustable load to satisfy various test requirements. In addition, the heat exchange fluid in a pipeline where the heating container is located in the adjustable load keeps unidirectional flow, which can reduce the dead zone volume and improve the accuracy of the test.

### BRIEF DESCRIPTION OF THE DRAWINGS

FIG. 1 is a structural diagram of a magnetic refrigerator according to an embodiment of the present disclosure and a testing system therefor;

FIG. 2A is a graph showing the change of a magnetic field in a magnetic regenerator module of a magnetic refrigerator in time according to the embodiment of the present disclosure;

FIG. 2B is an operating mode diagram of two magnetic regenerator modules of a magnetic refrigerator according to the embodiment of the present disclosure;

FIG. 3A to FIG. 3C are a cold end temperature curve and a hot end temperature curve of a magnetic regenerator module in a testing system according to the embodiment of the present disclosure when heating power of a heater with an adjustable load is respectively 0 W, 10 W and 20 W.

In the drawings: T1-T8: first temperature sensor to eighth temperature sensor; H1: first magnetic regenerator module; H2: second magnetic regenerator module; C1: first magnetic field system; C2: second magnetic field system; DX1 to DX4: first check valve to fourth check valve; RBQ: heating container; 1: heater; 2: adjustable load; DF1-DF6: first electric control valve to sixth electric control valve; F1: first fixed load; F2: second fixed load.

### DETAILED DESCRIPTION OF THE EMBODIMENTS

The present disclosure is further described below with reference to specific embodiments, but the scope of protection of the present disclosure is not limited thereto.

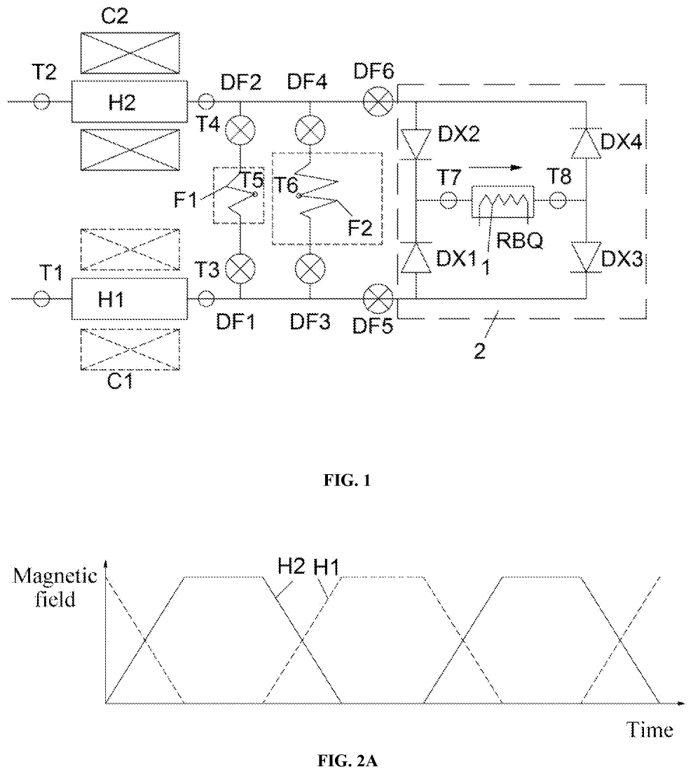

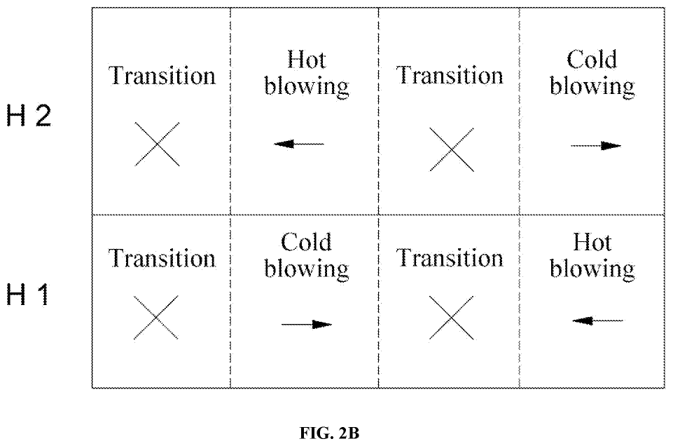

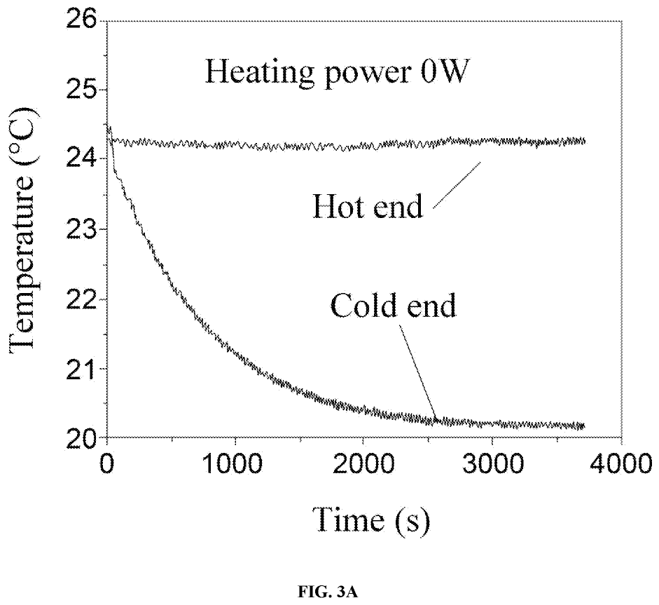

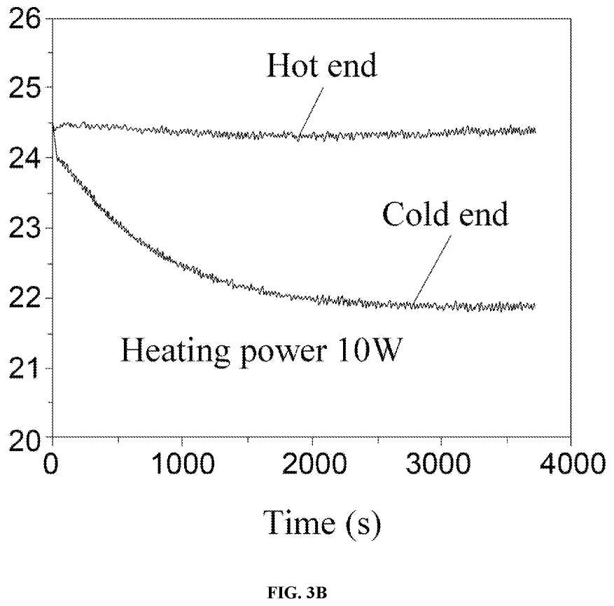

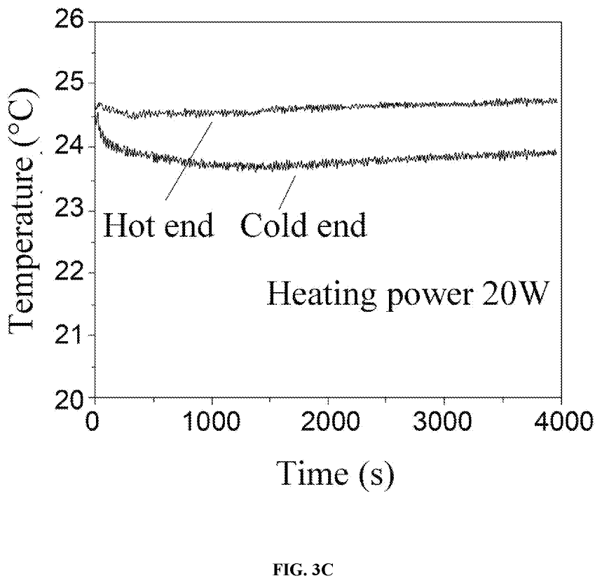

FIG. 1 is a structural diagram of a magnetic refrigerator according to an embodiment of the present disclosure and a testing system therefor. FIG. 2A is a graph showing the change of a magnetic field in a magnetic regenerator module of a magnetic refrigerator in time according to the embodiment of the present disclosure. FIG. 2B is an operating mode diagram of two magnetic regenerator modules of a magnetic refrigerator according to the embodiment of the present disclosure. FIG. 3A to FIG. 3C are a cold end temperature curve and a hot end temperature curve of a magnetic regenerator module in a testing system according to the embodiment of the present disclosure when heating power of a heater with an adjustable load is respectively 0 W, 10 W and 20 W.

Referring to FIG. 1, a testing system for a magnetic refrigerator is provided according to an embodiment of the present disclosure. The magnetic refrigerator includes magnetic regenerator modules arranged in pairs.

A first magnetic regenerator module H1, a second magnetic regenerator module H2, a first magnetic field system C1, a second magnetic field system C2, and first to fourth temperature sensors T1 to T4 in the magnetic refrigerator are shown in FIG. 1.

The first magnetic regenerator module H1 may include, for example, one active magnetic regenerator, or multiple active magnetic regenerators connected in parallel, or multiple active magnetic regenerators connected in series.

The second magnetic regenerator module H2 may include, for example, one active magnetic regenerator, or multiple active magnetic regenerators connected in parallel, or multiple active magnetic regenerators connected in series.

The first magnetic regenerator module H1 and the second magnetic regenerator module H2 have equal refrigeration power.

The first magnetic field system C1 and the second magnetic field system C2 are used to provide magnetic fields for the first magnetic regenerator module H1 and the second magnetic generator module H2, respectively.

The first temperature sensor T1 is arranged at a hot end of the first magnetic regenerator module H1, and is used to detect a temperature of a heat exchange fluid at the hot end of the first magnetic regenerator module H1.

The third temperature sensor T3 is arranged at a cold end of the first magnetic regenerator module H1, and is used to detect a temperature of the heat exchange fluid at the cold end of the first magnetic regenerator module H1.

The second temperature sensor T2 is arranged at a hot end of the second magnetic regenerator module H2, and is used to detect a temperature of the heat exchange fluid at the hot end of second magnetic regenerator module H2.

The fourth temperature sensor T4 is arranged at a cold end of the second magnetic regenerator module H2, and is used to detect a temperature of the heat exchange fluid at the cold end of the second magnetic regenerator module H2.

Alternatively, hot end temperatures of the magnetic regenerator modules arranged in pairs are set to be constant and equal.

Alternatively, the hot end temperatures of the magnetic regenerator modules arranged in pairs are not forced to be set to be constant, for example, the hot end is used for convection heat dissipation.

The adjustable load 2 in the testing system includes a heating container RBQ, and a flow direction control structure (which refers to a first check valve DX1 to a fourth check valve DX4 in FIG. 1).

The heating container RBQ is provided with an inlet, an outlet, and a heater 1 with controllable heating power. The flow direction control structure is configured to enable the heat exchange fluid flowing out from the cold end of any magnetic regenerator module in the magnetic regenerator modules arranged in pairs to flow into the cold end of another magnetic regenerator module through the inlet and outlet of the heating container RBQ in sequence. The heater 1 is used to heat the heat exchange fluid inside the heating container RBQ, and an on-off state between the adjustable load 2 and the cold end of any magnetic regenerator module is controllable.

Specifically, the flow direction control structure includes a first check valve DX1, a second check valve DX2, a third check valve DX3, and a fourth check valve DX4.

An inlet of the first check valve DX1 and an outlet of the third check valve DX3 both communicate with the cold end of the first magnetic regenerator module H1 through a fifth electric control valve DF5. An inlet of the second check valve DX2 and an outlet of the fourth check valve DX4 both communicate with the cold end of the second magnetic regenerator module H2 through a sixth electric control valve DF6. An outlet of the first check valve DX1 and an outlet of the second check valve DX2 both communicate with a heat exchange fluid inlet of the heating container RBQ. An inlet of the third check valve DX3 and an inlet of the fourth check valve DX4 both communicate with a heat exchange fluid outlet of the heating container RBQ.

Specifically, an arrow above the heating container RBQ in FIG. 1 is a flow direction of the heat exchange fluid in the heating container RBQ.

The flow direction control structure (e.g., the check valves DX1 to DX4 in FIG. 1) ensures that the heat exchange fluid flowing through the heating container RBQ always flows unidirectionally. After unidirectional flow, the heat exchange fluid in a pipe network moves farther, the heat exchange is more sufficient, and the temperature of the heat exchange fluid in the pipe network is more uniform. Therefore, the dead volume in the heat exchange fluid is reduced, which can improve the accuracy of refrigeration power measurement.

The on-off state of the check valve depends on a pressure difference of the fluid at both ends, and there is no need to set up an electrical signal to control on-state of the check valve separately.

In some other embodiments, the check valve may be replaced with an electric control valve.

Referring to FIG. 1, a flow direction of the heat exchange fluid in the pipe network may be from the cold end of the first magnetic regenerator module H1 to the heat exchange fluid inlet of the heating container RBQ through the fifth electric control valve DF5 and the first check valve DX1, and then from the heat exchange fluid outlet of the heating container RBQ to the second magnetic regenerator module H2 through the fourth check valve DX4 and the sixth electric control valve DF6. The flow direction of the heat exchange fluid in the pipe network may also be from the cold end of the second magnetic regenerator module H2 to the heat exchange fluid inlet of the heating container RBQ through the sixth electric control valve DF6 and the second check valve DX2, and then from the heat exchange fluid outlet of the heating container RBQ to the first magnetic regenerator module H1 through the third check valve DX3 and the fifth electric control valve DF5.

At least one fixed load is arranged in the testing system. A first end of any fixed load communicates with the cold end of one magnetic regenerator module in the magnetic regenerator modules arranged in pairs in a controller manner, and a second end of any fixed load communicates with the cold end of another magnetic regenerator module in the magnetic regenerator modules arranged in pairs in a controlled manner.

In the embodiment shown in FIG. 1, one end of the first fixed load F1 communicates with the cold end of the first magnetic regenerator module H1 through a first electric control valve DF1, and the other end of the first fixed load F1 communicates with the cold end of the second magnetic regenerator module H2 through a second electric control valve DF2. one end of the second fixed load F2 communicates with the cold end of the first magnetic regenerator module H1 through a third electric control valve DF3, and the other end of the second fixed load F2 communicates with the cold end of the second magnetic regenerator module H2 through the fourth electric control valve DF4.

The first fixed load F1 is, for example, a relatively short pipeline, and the second fixed load is, for example, a relatively long pipeline. The heat capacity of the first fixed load F1 is less than that of the second fixed load F2.

The testing system includes multiple temperature sensors, which are used to measure a temperature of the heat exchange fluid at each of the hot end and the cold end of at least one of the magnetic regenerator modules arranged in pairs, a temperature of the heat exchange fluid at the heating container, and a temperature of the heat exchange fluid at each fixed load.

In some embodiments, the multiple temperature sensors include:
a first temperature sensor T1, used to measure the temperature of the heat exchange fluid at the hot end of the first magnetic regenerator module H1;
a second temperature sensor T2, used to measure the temperature of the heat exchange fluid at the hot end of second first magnetic regenerator module H2;
a third temperature sensor T3, used to measure the temperature of the heat exchange fluid at the cold end of the first magnetic regenerator module H1;
a fourth temperature sensor T4, used to measure the temperature of the heat exchange fluid at the cold end of the second magnetic regenerator module H2;
a fifth temperature sensor T5, used to measure the temperature of the heat exchange fluid in the first fixed load F1;
a sixth temperature sensor T6, used to measure the temperature of the heat exchange fluid in the second fixed load F2;
a seventh temperature sensor T7, used to measure the temperature of the heat exchange fluid at the heat exchange fluid inlet of the heating container RBQ; and
an eighth temperature sensor T8, used to measure the temperature of the heat exchange fluid at the heat exchange fluid outlet of the heating container RBQ.

It should be noted that in some embodiments, the default is that the two magnetic regenerator modules are consistent in performance, so it is only necessary to provide temperature sensors at the hot end and the cold end of one magnetic regenerator module. In some embodiments, the temperature sensor is arranged only at the heat exchange fluid inlet or heat exchange fluid outlet of the heating container RBQ or only inside the heating container RBQ.

The present disclosure employs the following technical solution: a testing method applied to the testing system for a magnetic refrigerator includes the following steps:

An adjustable load 2 is set to be in conducting with a cold end of any magnetic regenerator module, at least one fixed load F1 or F2 is set to be disconnected from the cold end of any magnetic regenerator module, heating power of a heater RBQ is set, and a change curve of a cold end temperature and a change curve of a hot end temperature of any magnetic regenerator module with time are measured.

Referring to FIG. 1 and FIG. 2A and FIG. 2B, in four stages of one cycle period of the magnetic refrigerator, a first stage is a transition period, and the heat exchange fluid is in a static state. In a second stage, when the first magnetic regenerator module H1 is in a demagnetized state, the heat exchange fluid flows out from the cold end of the first magnetic regenerator module H1, passes through the fifth electric control valve DF5, the first check valve DX1, the heating container RBQ (for example, a thermal compensator), the fourth check valve DX4 and the sixth electric control valve DF6, and then flows through the magnetized second magnetic regenerator module H2 to discharge heat. In a third stage, the heat exchange fluid is static. In a fourth stage, when the second magnetic regenerator module H2 is in a demagnetized state, the heat exchange fluid flows out from the cold end of the second magnetic regenerator module H2, passes through the sixth electric control valve DF6, the second check valve DX2, the heating container RBQ, the third check valve DX3 and the fifth electric control valve DF5, and then flows to the magnetized first magnetic regenerator module H1 to discharge heat, thus completely one periodic cycle.

Referring to FIG. 3A to FIG. 3C, in a testing example, the hot ends of the first and second magnetic regenerator modules H1 and H2 are kept basically constant, and the heating power of the adjustable load is 0 W, 10 W and 20 W, respectively, and the change curve of the cold end temperature with time is measured.

In some another testing scenarios, the adjustable load 2 is set to be disconnected from the cold end of any magnetic regenerator module, one fixed load (e.g., the first fixed load F1) is set to be in conducting with the cold end of any magnetic regenerator module, the rest fixed load (e.g., the second fixed load F2) is set to be disconnected from the cold end of any magnetic regenerator module, and a change curve of THE cold end temperature and a change curve of the hot end temperature of any magnetic regenerator module with time are measured.

In these testing scenarios, an appropriate fixed load can be selected as required, and the refrigeration performance of magnetic refrigerator for fixed load.

The embodiments in the present disclosure are described in a progressive way. For same or similar parts of the embodiments, references can be made to the embodiments mutually. Each embodiment focuses on a difference from other embodiments.

The scope of protection of the present disclosure is not limited to above embodiments. Apparently, those skilled in the art make various modifications and variations to the present disclosure without departing from the scope and spirit of the present disclosure. If these modifications and variations fall within the scope of the claims and their equivalents, it is intended that these modifications and variations be included in the present disclosure.

What is claimed is:

1. A testing system for a magnetic refrigerator, wherein the magnetic refrigerator comprises magnetic regenerator modules arranged in pairs, and the testing system comprises:
an adjustable load, comprising a heating container, and a flow direction control structure, wherein the heating container is provided with an inlet, an outlet, and a heater with controllable heating power, the flow direction control structure is configured to enable a heat exchange fluid flowing out from a cold end of any magnetic regenerator module in the magnetic regenerator modules arranged in pairs to flow into a cold end of another magnetic regenerator module through the inlet and outlet of the heating container in sequence, the heater is used to heat the heat exchange fluid inside the heating container, and an on-off state between the adjustable load and the cold end of any magnetic regenerator module is controllable;
at least one fixed load, wherein a first end of any fixed load communicates with the cold end of one magnetic regenerator module in the magnetic regenerator modules arranged in pairs in a controlled manner, and a second end of the any fixed load communicates with the cold end of another magnetic regenerator module in the magnetic regenerator modules arranged in pairs in a controlled manner; and
a plurality of temperature sensors, used to measure a temperature of the heat exchange fluid at each of a hot end and the cold end of at least one of the magnetic regenerator modules arranged in pairs, a temperature of the heat exchange fluid at the heating container, and a temperature of the heat exchange fluid at each fixed load.

2. The testing system according to claim 1, wherein the magnetic regenerator modules arranged in pairs are respectively a first magnetic regenerator module and a second magnetic regenerator module, and the flow direction control structure comprises a first check valve, a second check valve, a third check valve, and a fourth check valve;
an inlet of the first check valve and an outlet of the third check valve both communicate with the cold end of the first magnetic regenerator module through a same electric control valve, an inlet of the second check valve, and an outlet of the fourth check valve both communicate with the cold end of the second magnetic regenerator module through a same electric control valve, an outlet of the first check valve and an outlet of the second check valve both communicate with a heat exchange fluid inlet of the heating container, and an inlet of the third check valve and an inlet of the fourth check valve both communicate with a heat exchange fluid outlet of the heating container.

3. The testing system according to claim 2, wherein both ends of any fixed load communicate the cold ends of the corresponding magnetic regenerator modules through electric control valve, respectively.

4. The testing system according to claim 1, wherein the at least one any fixed load comprises a first fixed load and a second fixed load, wherein a heat capacity of the first fixed load is less than that of the second fixed load.

5. The testing system according to claim 1, wherein the magnetic regenerators modules arranged in pairs have equal refrigeration power.

6. The testing system according to claim 1, wherein each of the magnetic regenerator modules arranged in pairs has one or more active magnetic regenerators communicating with one another.

7. The testing system according to claim 1, wherein hot end temperatures of the magnetic regenerator modules arranged in pairs are set to be constant and equal.

8. A testing method applied to the testing system for the magnetic refrigerator according to claim 1, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

9. A testing method applied to the testing system for the magnetic refrigerator according to claim 2, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

10. A testing method applied to the testing system for the magnetic refrigerator according to claim 3, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

11. A testing method applied to the testing system for the magnetic refrigerator according to claim 4, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

12. A testing method applied to the testing system for the magnetic refrigerator according to claim 5, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

13. A testing method applied to the testing system for the magnetic refrigerator according to claim 6, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

14. A testing method applied to the testing system for the magnetic refrigerator according to claim 7, comprising the following steps:
setting an adjustable load to be in conducting with a cold end of any magnetic regenerator module, setting at least one fixed load to be disconnected from the cold end of any magnetic regenerator module, setting heating power of a heater, and measuring a change curve of a cold end temperature and a change curve of a hot end temperature of any magnetic regenerator module with time.

15. The method according to claim 8, wherein the hot end temperatures of the magnetic regenerator modules arranged in pairs are set to be constant and equal.

16. The method according to claim 9, wherein the hot end temperatures of the magnetic regenerator modules arranged in pairs are set to be constant and equal.

17. The method according to claim 10, wherein the hot end temperatures of the magnetic regenerator modules arranged in pairs are set to be constant and equal.

18. The method according to claim 11, wherein the hot end temperatures of the magnetic regenerator modules arranged in pairs are set to be constant and equal.

19. The method according to claim 12, wherein the hot end temperatures of the magnetic regenerator modules arranged in pairs are set to be constant and equal.

20. The method according to claim 8, further comprising the following steps:
setting the adjustable load to be disconnected from the cold end of any magnetic regenerator module, setting at least one fixed load to be in conducting with the cold end of any magnetic regenerator module, setting rest fixed loads to be disconnected from the cold end of any magnetic regenerator module, and measuring a change curve of the cold end temperature and a change curve of the hot end temperature of any magnetic regenerator module with time.
